(19) United States
(12) Patent Application Publication
(10) Pub. No.: US 2026/0129467 A1
(43) Pub. Date: May 7, 2026

(54) SYSTEMS AND METHODS FOR PLANNING AND DEPLOYMENT OF NETWORK UPGRADES IN URBAN ENVIRONMENTS

(71) Applicant: Telefonaktiebolaget LM Ericsson (publ), Stockholm (SE)

(72) Inventor: Tahar ZANOUDA, SOLNA (SE)

(73) Assignee: Telefonaktiebolaget LM Ericsson (publ), Stockholm (SE)

(21) Appl. No.: 19/117,902

(22) PCT Filed: Oct. 3, 2022
(86) PCT No.: PCT/EP2022/077489

§ 371 Date: Apr. 2, 2025

(51) Int. Cl. H04W 16/18; H04B 17/318; H04L 1/00; H04L 41/5009; H04L 41/5067

(52) U.S. Cl. CPC H04W 16/18; H04B 17/328; H04L 1/0003; H04L 41/5009; H04L 41/5067

(57) ABSTRACT

A method of managing a wireless communication network includes obtaining network configuration and network performance data for the wireless communication network and urban infrastructure data for a geographic area. A plurality of structure topologies of structures in the geographic area are extracted from the urban infrastructure data. Respective ones of the structure topologies are associated with one or more cells of the wireless communication network. The performance of the wireless communication network at the plurality of structures is assessed based on the network configuration and performance data, and, for each of the structures, a benefit metric is generated that indicates a potential benefit associated with upgrading or deploying wireless communication network equipment. Related systems and computer program products are disclosed.

### BACKGROUND

The present disclosure relates to wireless communication networks, and in particular to network planning for indoor network equipment deployment.

Telecommunication networks provide the communication and information backbone of the digital economy. The demand for wireless telecommunication services is particularly high in urban environments. Accordingly, it is desirable for operators of wireless telecommunication services in an urban environment to provide reliable services anywhere in the environment. This may be challenging, however, due to the fact that buildings and other structures in urban environments, and particularly in dense urban environments, can cause attenuation of wireless signals or create reflections that can make the planning and deployment of wireless infrastructure, such as base-stations, difficult.

As people tend to spend more time in indoor environments, telecommunication network operators aim to provide seamless indoor 5G coverage and deliver high-quality indoor 5G experiences in indoor environments. Recent studies indicate that more than 80% of data traffic are generated indoors. Taken together, the connectivity demand and the increased usage of smartphones indoors present a challenge for operators to offer the same level of quality for users in both indoor and outdoor environments. To achieve this goal, mobile operators are continuously expanding the network and modernizing their hardware and software to cope with these challenges. However, the process of determining the location and hardware used in the site is a time consuming and tedious process.

Telecommunication service providers may continually modernize their networks to achieve maximum coverage with minimal cost. Typically, mobile (wireless) network operators monitor the performance of the network after deploying the network to avoid network failures and performance degradation. Such problems in a deployed network are usually a result of a growing population, and the expansion of the urban infrastructure in a target region.

In cities where weather conditions are extreme (e.g., Middle East, Canada, etc.), users tend to spend more time in indoor environments. With limited resources and high number of potential buildings, operators need a consistent and data-driven approach to prioritize certain regions or buildings. Providing seamless coverage for users in indoor environments may be a particularly challenging and expensive process.

### SUMMARY

A method of planning an upgrade of a wireless communication network according to some embodiments includes obtaining network configuration and network performance data for the wireless communication network and urban infrastructure data for a geographic area of interest. A plurality of building topologies of buildings in the geographic area of interest are extracted from the urban infrastructure data. Respective ones of the building topologies are associated with one or more cells of the wireless communication network. The performance of the wireless communication network at the plurality of buildings is assessed based on the network configuration and performance data, and, for each of the buildings, a benefit metric is generated that indicative of a potential benefit associated with upgrading and/or deploying wireless network equipment in the wireless communication network. The benefit metric is based on the assessed performance of the wireless communication network at the building and a topological characteristic of the building obtained from plurality of building topologies.

The method may further include ranking the buildings according to the metric.

The method may further include categorizing the buildings as indoor or outdoor locations. Generating the metric includes generating the metric for buildings categorized as indoor locations.

The urban infrastructure data may include satellite imagery data, and extracting the plurality of building topologies may include applying a machine learning model to the satellite imagery data to obtain the plurality of building topologies.

Assessing the performance of the wireless communication network may include assessing key performance indicators of the wireless communication network relating to traffic volume, network accessibility, resource utilization, energy performance and/or path loss of the wireless communication network relative to the plurality of building topologies.

Associating respective ones of the building topologies with one or more cells of the wireless communication network may include generating a map of a geographic coverage of a cell of the wireless communication network, and determining an overlap of the plurality of building topologies with the geographic coverage of the cell of the wireless communication network.

Associating respective ones of the building topologies with one or more cells of the wireless communication network may include associating respective ones of the building topologies with one or more sectors of one or more cells of the wireless communication network.

The network performance data may include key performance indicators, KPIs, that measure network customer usage data and network demand.

Assessing performance of the wireless communication network within the one or more cells may take into one or more of: throughput, quality of service (QoS), quality of experience (QoE), dropped calls, dropped packets, system bandwidth, modulation and coding schemes (MCS) used in a cell/sector, reference signal received power (RSRP), and reference signal received quality (RSRQ).

The method may further include generating a recommended upgrade action for each of the buildings. The recommend upgrade action comprises upgrading hardware or software of existing network equipment, deploying new indoor network equipment and/or deploying new outdoor network equipment.

Generating the benefit metric may include obtaining input metrics for a plurality of factors associated with the building, normalizing the input metrics, and combining the input metrics to obtain the benefit metric. The benefit metric may be a vector of the input metrics.

The method may further include ranking the buildings according to a size of the vector of the input metrics. The input metrics may include one or more of building surface area, building-cell distance, traffic volume, accessibility KPIs, resource utilization, energy use and consumption, and path loss.

The topological characteristic of the building may include a surface area of the building, a distance of the building from a cell of the wireless communication network, and/or a height of the building.

The network configuration and network performance data may be obtained from the wireless communication network operator.

The building topologies may include two dimensional building footprints and/or three dimensional building shapes.

The upgrade may include a software upgrade of indoor or outdoor network equipment serving the building and/or installation of new indoor or outdoor network equipment serving the building.

In some embodiments, the method further includes upgrading the wireless communication network based on the benefit metric.

An upgrade recommendation system for a wireless communication system according to some embodiments includes a memory comprising instruction data representing a set of instructions, and a processor configured to communicate with the memory and to execute the set of instructions. The set of instructions, when executed by the processor, causes the processor to obtain network configuration and network performance data for the wireless communication network, obtain urban infrastructure data for a geographic area of interest, and extract a plurality of building topologies of buildings in the geographic area of interest from the urban infrastructure data. The instructions further cause the processor to associate respective ones of the building topologies with one or more cells of the wireless communication network, and assess performance of the wireless communication network at the plurality of buildings based on the network configuration and performance data.

For each of the buildings, the instructions cause the processor to generate a benefit metric indicative of a potential benefit associated with upgrading and/or deploying wireless network equipment based on the assessed performance of the wireless communication network at the building and a topological characteristic of the building obtained from the plurality of building topologies.

Some embodiments provide a computer program comprising instructions which, when executed on at least one processor, cause the at least one processor to carry out a method as described above. Some embodiments provide a carrier containing the computer program, wherein the carrier is one of an electronic signal, optical signal, radio signal or computer readable storage medium. Some embodiments provide a computer program product comprising non transitory computer readable media having the computer program stored thereon.

### BRIEF DESCRIPTION OF DRAWINGS

FIG. 1 shows operations of systems/methods according to some embodiments for performing macro-level indoor deployment planning for a wireless communication network.

FIG. 2 is a flowchart of operations for generating building footprints according to some embodiments.

FIG. 3 shows a map of a geographic location from building footprints in the geographic area have been identified.

FIG. 4 shows the map of a geographic area of interest on which a sector of a cell has been plotted.

FIG. 5 shows the map on which the sector of the cell and the building footprints 304 have been plotted.

FIG. 6 is a flowchart of operations for identifying existing indoor sites in a geographic area according to some embodiments.

FIG. 7 shows operations for assessing network performance according to some embodiments.

FIG. 8 illustrates an example of a system for generating indoor deployment recommendations according to some embodiments.

FIG. 9 is a block diagram illustrating elements of an indoor installation recommendation system according to some embodiments.

FIG. 10 illustrates various functional modules stored in the memory of the indoor installation recommendation system according to some embodiments.

FIG. 11A shows a node in a communications network according to some embodiments.

FIG. 11B shows three example node configurations in a communications network according to some embodiments.

FIG. 12 shows a method in a node in a communications network according to some embodiments.

FIG. 13 shows a node in a communications network according to some embodiments.

FIG. 14 shows a method in a node in a communications network according to some embodiments.

FIG. 15 illustrates a sector according to some embodiments.

FIG. 16 shows a method of training a model according to some embodiments.

FIG. 17 shows a system according to some embodiments.

FIG. 18 shows another system according to some embodiments.

### DETAILED DESCRIPTION OF EMBODIMENTS

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

As noted above, there is a large demand for wireless communication services in urban environments where a significant number of users are located indoors. Wireless network coverage is typically provided to indoor users via outdoor base-stations. However, it can be a challenge to serve indoor traffic using outdoor base-stations due to radio signal attenuation, which lead to poor indoor coverage. The weak network signal attenuated by physical obstacles may lead indoor users to consume more radio resources, which can constrain outdoor users resource usage. With 5G networks and beyond, this can be a challenge because of use of high frequency bands.

To address these challenges, 5G technologies vendors may provide dedicated indoor solutions including modular indoor radio systems to extend and distribute the wireless network signal within buildings. The architecture involves a set of small-cell radios that can be installed inside buildings to increase network capacity. Such systems are customized to cope with connectivity demands in vibrant and dense indoor environments such as subway stations, shopping malls, airport terminals, factories, and hospitals. Operators typically desire to strategically determine the location of buildings to deploy indoor system such that enhanced coverage is achieved with minimal cost. However, the deployment of indoor sites is typically expensive and labor intensive. Therefore, there is a need to prioritize certain geographic regions or buildings before deploying indoor infrastructure.

Determining where within a building to place indoor wireless communication equipment is referred to as micro-level planning. In contrast, macro-level planning involves identifying buildings within an urban environment that may benefit from deployment of indoor wireless communication equipment. Macro-level planning may be difficult, because often a network operator may have little awareness of the wireless environment or service needs within an existing building.

Existing approaches for macro-level planning of indoor deployment has many other challenges. For example, in cities where weather conditions are extreme (e.g., Middle East, etc.), users tend to spend more time in indoor environments. With limited resources and high number of potential buildings, operators need a consistent and data-driven approach to prioritize certain regions or buildings.

Traditional methods of macro-level planning rely on a manual process to collect data from different sources to find optimal places with help of domain experts. Such approaches may have problems accessing building layouts and tend to be limited to specific regions.

Many efforts to plan the installation of indoor systems typically rely solely on analyzing historical network patterns, which may ignore the evolving urban infrastructure. In fast growing cities, the built-up area changes constantly. It is a very costly and uncertain process to assess the need to install indoor systems for new regions and buildings.

In many regions, mobile operators tend to trust explainable recommendation systems to invest on site modernization. Traditional approaches tend to be subjective in nature and are not easily explainable through objective analysis. For example, network infrastructure upgrade plans are often based on the assumptions of network engineers, which make it hard to assess the degree of need to install indoor systems in consistent manner.

Some embodiments described herein may address one or more of these issues by providing systems/methods that identify and prioritize optimal places to deploy indoor networks from a macro level. Some embodiments described herein may provide a practical and explainable approach to help network operators modernize sites and select regions that can benefit from deployment of indoor network equipment, particularly in 5G systems.

In particular, some embodiments identify new places to deploy indoor equipment in a telecommunication network using telecommunication data obtained from the telecommunication network and urban infrastructure data, such as satellite imagery and LiDAR (light detection and ranging) data, for the geographic area. Potential deployment sites are identified, analyzed and ranked that can benefit from deployment of new hardware equipment, such as 5G indoor equipment, according to embodiments described herein.

Some embodiments take into account both network performance and energy consumption to identify sites that require an upgrade procedure. The method may use urban infrastructure data, such as satellite imagery, 3D buildings or LiDAR data, to extract building topologies and overcome any location-data availability bias.

Potential deployment sites may be analyzed based on their building topologies, which may be obtained from various sources including satellite imagery data or LiDAR data. Extracting building topologies from available data may be performed continuously. Systems/methods described herein may continuously mine satellite imagery data or LiDAR data to capture city growth and update the recommendations accordingly. It will be appreciated that building topologies may include two-dimensional building footprints, three-dimensional building shapes and/or other information regarding building shape, size, orientation, location, construction and/or material. Building footprints can be also obtained directly from third-party providers or government portals.

Some embodiments described herein use historical network field data to Identify and rank potential locations that can benefit from upgrade recommendations. Such data may be updated from time to time to reflect changes in the geographical region where the site is deployed.

Moreover, some systems/methods described herein may consider building penetration losses, which may be used to rank sites for recommended actions. Installing in-building communication equipment in buildings with high indoor traffic may make the solution more energy efficient and/or more economical.

Some embodiments described herein may provide certain advantages. For example, some embodiments may provide an automated and data-driven approach to identify locations that can benefit from installing new indoor hardware equipment or upgrading an existing site.

Some embodiments described herein may provide systems/methods to assist operators to prioritize efforts to install indoor equipment in different cities across the globe.

Using the systems/methods described herein, mobile network operators can have a consistent way to identify and prioritize sites that require upgrade actions. The method is explainable and does not rely on end-to-end black box models. By using the systems/methods described herein, expenses may be reduced for tasks that are often handled by network support engineers.

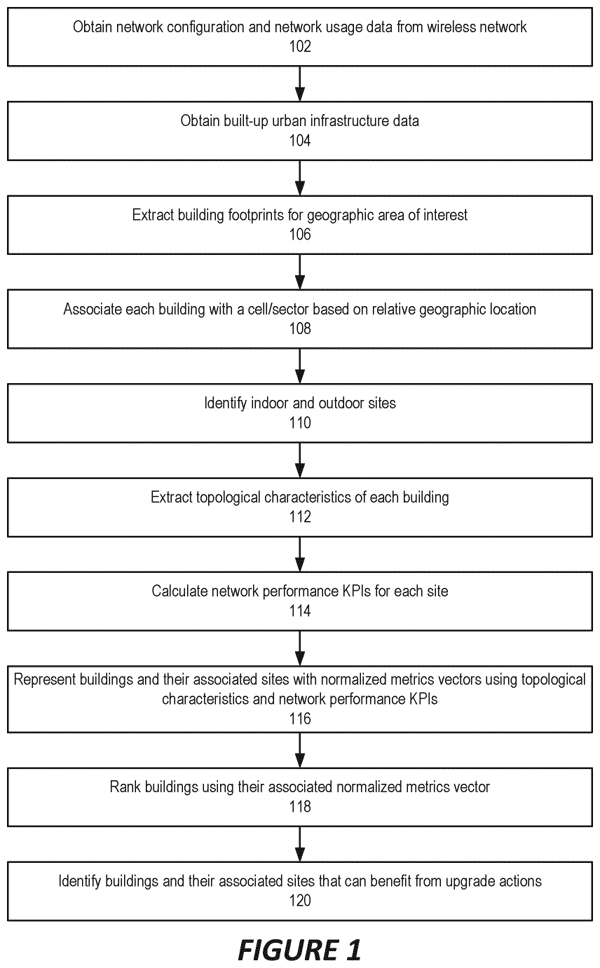

Operations of systems/methods according to some embodiments for performing macro-level indoor deployment planning for a wireless communication network are illustrated in FIG. 1. As shown therein, network configuration and usage data are obtained from the wireless communication network (block 102). In particular, live network data may be collected from the wireless communication network. The collected data may include key performance indicators (KPIs) that measure network customer usage data and network demand. Additionally, site configuration data describing existing installed network infrastructure may collected to assess the performance of the existing hardware configuration. Network performance data consisting of historical performance management data and cell configuration management attributes may also be collected.

At block 104, data relating to the built-up urban infrastructure is obtained. The data may include maps, layouts, footprints, building heights, building types, or other information about buildings and structures in the relevant geographic area. The identified structures may include any structure within the geographic area including, without limitation, office buildings, apartment buildings, schools, stadiums, arenas, churches, halls, etc. Each structure within the geographic area may be represented by the systems/methods a discrete location within the geographic area that can be analyzed to determine if the structure may benefit from installation of indoor wireless communication equipment.

Such information may be obtained in a number of ways, such as from public databases, publicly accessible mapping services, private data providers and others. As a non-limiting example, urban map data may be obtained from an online satellite map provider such as Google Earth or Sentinel-2.

Identified sites may be segmented based on technology and deployment scenarios. Segmenting sites with the same configuration enables the systems/methods to analyze the performance of homogenous groups of cells. For example, sites may be segmented as LTE, NR, standalone/non-standalone, indoor 5G, etc.

At block 106, buildings and other structures are identified and building footprints are extracted from the urban infrastructure data. Some embodiments described herein may use time series satellite imagery data to extract the footprints of buildings within the geographic area.

Satellite imagery, i.e., images of Earth collected by imaging satellites, can be obtained from various third-party data providers (e.g., Sentinel-2). Satellite imagery has characteristics of spatial (or geometric) resolution, spectral resolution, temporal resolution, and radiometric resolution. These characteristics makes satellite imagery data suitable source to capture changes of urban infrastructure over time at high resolution, regardless of the region. The systems/methods use built-up infrastructure data, such as satellite imagery data, that is available globally to make the method applicable for any region.

The systems/methods may generate buildings topologies using satellite imagery data and known computer vision/image processing methods. In particular, a machine learning (ML) model may be trained on an annotated satellite imagery dataset, and then use satellite imagery data from a given region to extract building topologies.

The primary goal of this step is to leverage this source of data to make the method scalable for any region using a global data source.

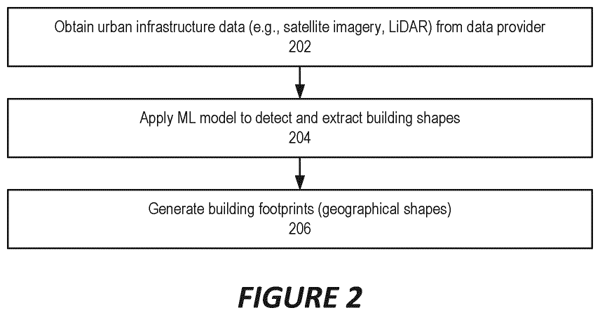

Brief reference is made to FIG. 2, which is a flowchart of operations for generating building footprints. As shown therein, the systems/methods obtain data, such as satellite imagery data and/or LiDAR data from a data provider (block 202). A state-of-the-art ML model, such as Mask R-CNN (a convolutional neural network-based method) or a Swin Transformer (a vision transformer-based method) is trained on an annotated satellite imagery dataset where buildings are identified and annotated. The trained model is then applied to detect and extract building shapes from the satellite imagery data (block 204). Building footprints are then generated as geometric shapes from the satellite imagery data (block 206).

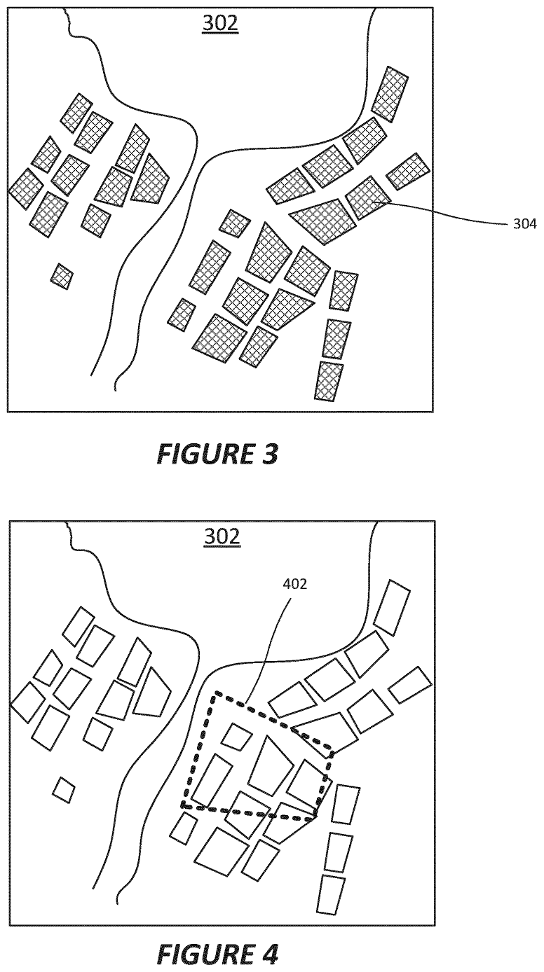

FIG. 3 illustrates a map 302 of a geographic location (e.g., a city) from which building footprints 304 in the geographic area have been identified.

Referring again to FIG. 1, at block 108, one or more identified buildings in the geographic area are associated with a cell and a sector of the wireless communication network based on the relative geographical location of the identified building and cell coverage data extracted from the network data. Based on this operation, one or more buildings within the geographic area may be associated with one or more cells/sectors of the wireless communication network as the cells/sectors that are most likely to provide existing communication services to the building.

Once the building footprints are determined, the systems/methods determine which building is associated with which sector. Sector coverage geographic region is calculated using site/cell location, antenna azimuth, and cell range. For each building, the systems/methods check to see if its geographic shape intersects with any sector coverage shape in the network. Each building is associated with a sector ID of the wireless network in this way.

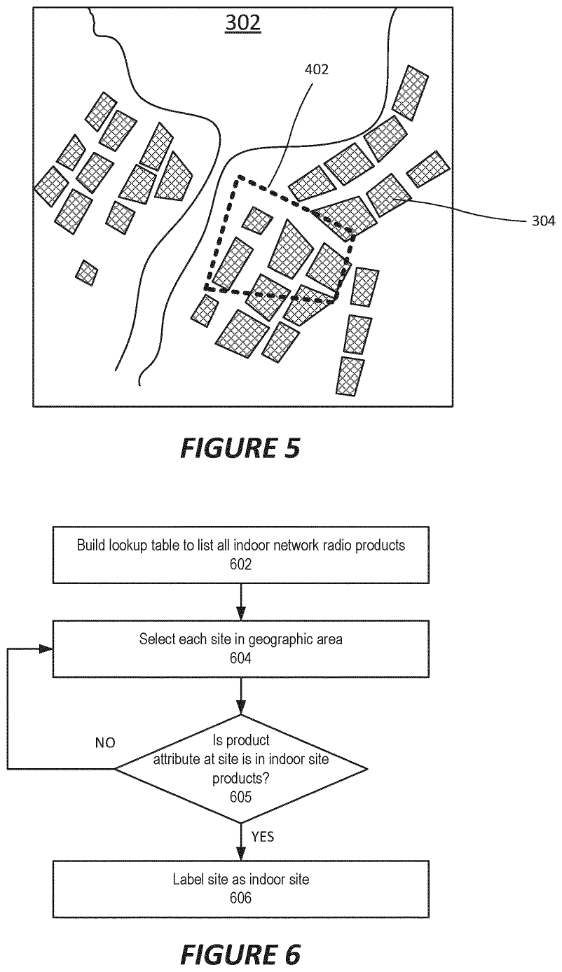

FIG. 4 illustrates the map 302 of a geographic area of interest on which a sector 402 of a cell has been plotted. FIG. 5 illustrates the map 302 on which the sector 402 of the cell and the building footprints 304 have been plotted. Buildings whose footprints at least partially overlap the sector 402 are considered to be associated with the sector 402.

Referring again to FIG. 1, at block 110, existing indoor and outdoor sites in the network are identified. For example, site configuration data may be used to identify existing indoor sites in the wireless communication network. The method focuses on finding new places where indoor system is needed. The method identifies and filters out existing indoor sites using site inventory data. Configuration data may be used to identify indoor sites. Brief reference is made to FIG. 6, which is a flowchart of operations for identifying existing indoor sites in a geographic area. As shown therein, the operations include building a lookup table to list all indoor network radio products (block 602). For each site, the operations check to see if any equipment located at the site has an attribute indicating that equipment is an indoor product. If so, the site is labeled as an indoor site. Otherwise, the site is labeled as an outdoor site.

At block 112, additional topological characteristics of the buildings, such as building height, building shape, building size, etc., are extracted from the data.

At block 114, the systems/methods calculate network performance KPIs for each site. The KPIs may include, but are not limited to, downlink and uplink throughputs, quality of service (QoS), quality of experience (QoE), dropped calls, dropped packets, system bandwidth, modulation and coding schemes (MCS) used in a cell/sector, reference signal received power (RSRP), reference signal received quality (RSRQ), or other indicators by which network performance may be assessed.

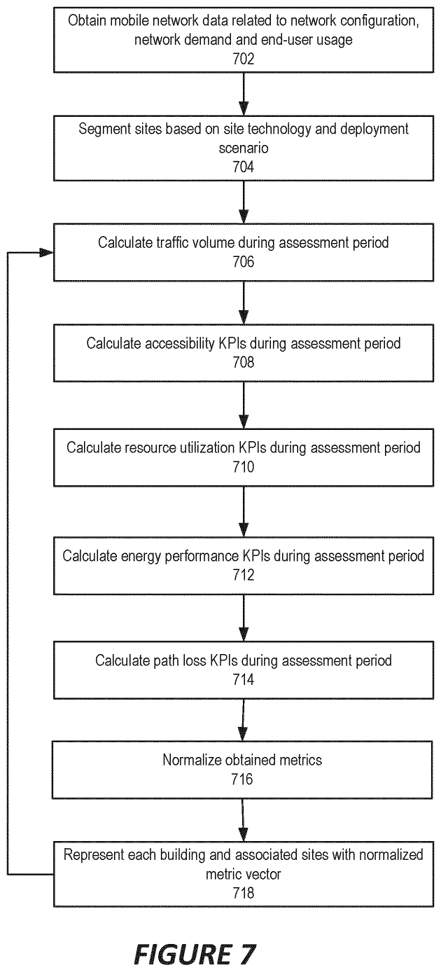

Performance management (PM) data of the network may be used to gauge network performance. PM data may be captured at regular intervals across network sites. Brief reference is made to FIG. 7, which illustrates operations for assessing network performance. As shown therein, mobile network data related to network configuration, network demand and end-user usage are gathered at block 702. At block 704, the sites are segmented based on site technology (e.g., LTE, NR, etc.) and deployment scenarios (standalone, non-standalone, dual connectivity, etc.).

Then for each group of sites in a network segment, the following operations are performed. First traffic volume is calculated for one or more assessment periods, which may include during busy and non-busy hours (block 706). This step helps to identify sites/cells serving largest amount of traffic. The obtained measurement data may comprise a number of users, downlink data volume, and/or uplink data volume at the cell/site.

The method then calculates accessibility KPIs during the assessment period (block 708). The method uses service performance measurements to calculate accessibility metrics, for example rate of successful call attempts by the users of the network. It is generally desirable to have high values for accessibility, and data throughput. KPIs can be derived using a set of counters, and the counter descriptions can vary across vendors and/or technologies.

The method then calculates resource utilization KPIs during the assessment period (block 710). For example, physical radio resource block utilization (PRB) for the downlink and uplink channels may be determined.

The method then calculates energy performance KPIs during the assessment period (block 712). A weak network signal attenuated by physical obstacles can lead to high resource usage and unnecessary energy consumption. Consumed energy is measured for each site. It is generally desirable to have lower values.

The method then calculates path loss KPIs during the assessment period (block 714). Path loss, in this context, refers to the radio signal power attenuation intensity. It is the results of signal traveling through an area. Uplink path loss distribution from performance management measurements is used as a proxy to estimate the indoor traffic. There is a higher path loss for a terminal located inside a building that is connected to an outdoor radio base-station than for one outdoors due to the building penetration loss.

The systems/methods may then normalize each of the obtained metrics (block 716), and then represent each building and its associated site with a normalized metric vector.

The operations of blocks 706-716 are repeated for each site.

Referring again to FIG. 1, at block 116, the systems/methods represent the buildings and their associated sites with normalized metric vectors using topological characteristics of the buildings and network performance KPIs.

At block 118, the systems/methods rank the analyzed structures according to the normalized metric vectors. That is the normalized metric vectors provide a benefit metric that indicates how much a particular building may benefit from an upgrade. In particular, the structures identified above are ranked as described in more detail below according to the likely improvement on performance of the wireless communication network that could be achieved by deploying indoor wireless communication equipment at the site, upgrading existing indoor or outdoor equipment, or deploying additional outdoor equipment near the site.

At block 120, using the ranking, the systems/methods identify buildings and their associated sites that can benefit from upgrade actions. For example, the systems/methods may provide a recommendation for upgrade actions based on network performance scores for sites that are often exposed to high traffic and/or that currently experience poor performance from the existing network infrastructure.

In order to prioritize network upgrade recommendations, and to identify optimal place to install indoor systems, systems/methods according to some embodiments may perform the following operations.

First, a surface area of each building is calculated. A distance between each building and the antenna of the associated cell is also calculated. It will be appreciated that one building can be associated to different cells/sectors.

The network performance metrics for each cell are then calculated.

The metric values (e.g., building surface area, building-cell distance, traffic volume, accessibility KPIs, resource utilization, energy use and consumption, path loss) are normalized so that, for example, all values fall within a certain range (e.g., 0-100) such that smaller values represent worse performance and larger values represent better performance, or vice-versa.

That is, to consider the same ascending/descending order for all metric values, some metric values (e.g., building surface area, building-cell distance, traffic volume, resource utilization, energy use, etc.) may be inverted so that high values can be identified.

For each building, the systems/methods construct a vector that represents a benefit metric that indicates how much a building may benefit from an upgrade based on one or more topological characteristics of the building and its associated cell performance. The vectors are ranked to identify buildings and their associated sites that can benefit from an upgrade action. For instance, the vectors may be sorted in ascending order so that large buildings that are exposed to high traffic, and poor user experience can be identified first.

Buildings represented by the vectors having the smallest magnitude represent cases where the site needs an upgrade action (determined in step 716 of FIG. 7 above). A site may require several upgrade actions, including installing indoor equipment.

A system/method as described above preferentially identifies regions with large buildings (i.e., buildings with highest surface area) from building topology, then identifies buildings that are densely populated or often exposed to high traffic (i.e., part of high traffic cluster). A recommendation is then generated for sites that suffer from poor network performance scores.

A recommended action may include a software or hardware upgrade at a base-station that serves as cell associated with the site as determined above. Alternatively or additionally, the recommended action may include the installation of indoor network equipment at the site, for example, to provide one or more nano- or pico-cells within the building.

Systems/methods described herein may enable a wireless communication network operator to prioritize geographic regions and buildings in term of network needs, while taking in consideration evolving urban infrastructure. Therefore, systems/methods described herein may reduce the time and resources spent to assess each geographic region separately. Moreover, the systems/methods described herein may work in near-real time, taking into consideration newly built buildings and recent changes in network usage behavior. Installing indoor systems in accordance with the generated recommendation may alleviate capacity issues for outdoor users, which may allow operators to maintain a good user experience across different regions in network.

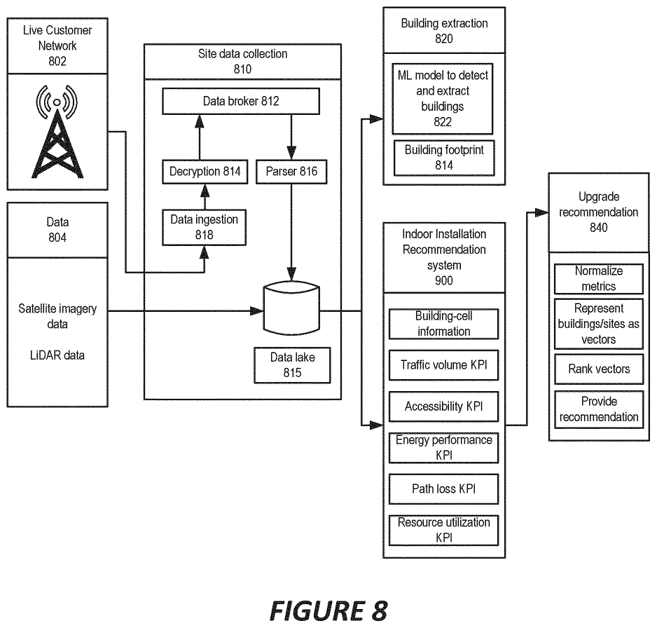

FIG. 8 illustrates an example of a system for generating indoor deployment recommendations as described above. As shown therein, satellite image data 804 are obtained as described above and stored in a data lake 815 in a site data collection unit 810.

Network performance data are extracted from a live customer network 802 by a data ingestion function in the site data collection unit 810. The data are decrypted 814 and provided to a data broker 812 that selects desired data from the network that is needed for the recommendation system. The data are parsed by a parser 816 and stored in the data lake 815.

The satellite image data and network data (including network configuration data and network performance data) are then provided to a building extraction unit 820 that uses a machine learning model 822 to detect buildings and associated topologies 824 from the satellite image data. The building topologies and network are provided to an indoor installation recommendation system 900. The indoor installation recommendation system 900 generates a recommendation 840 for equipment deployment or software upgrade based on the building topology information, cell information and relevant KPIs, such as traffic volume, accessibility, energy performance, path loss and resource utilization. In particular, the upgrade recommendation 840 may be generated based on a ranking of the normalized metric vectors for buildings.

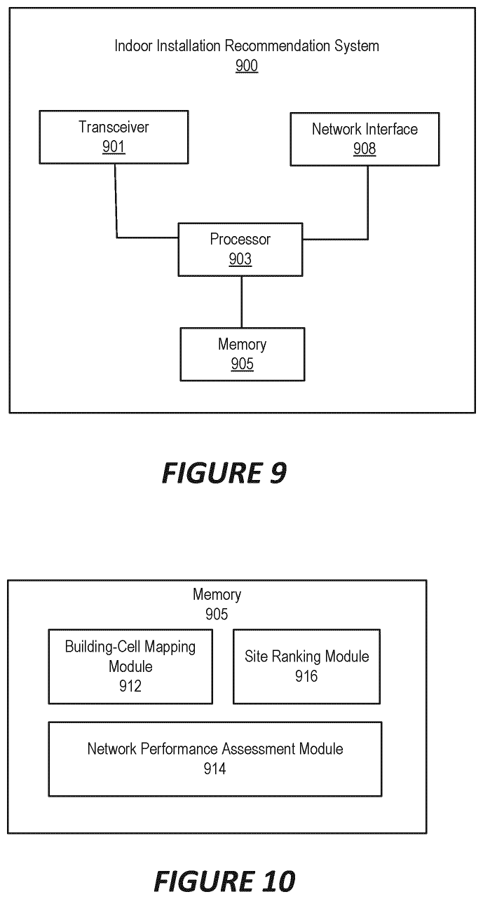

FIG. 9 is a block diagram illustrating elements of an indoor installation recommendation system 900 according to some embodiments. The system 900 may be provided by, e.g., a device in the cloud running software on cloud computing hardware; or a software function/service governing or controlling a wireless communication network. That is, the device may be implemented as part of a communications system, or on a device as a separate functionality/service hosted in the cloud. The device also may be provided as a standalone software for managing a wireless communication network; and the device may be in a deployment that may include virtual or cloud-based network functions (VNFs or CNFs) and even physical network functions (PNFs). The cloud may be public, private (e.g., on premises or hosted), or hybrid.

As shown, the device may include transceiver circuitry 901 (e.g., RF transceiver circuitry) including a transmitter and a receiver configured to provide uplink and downlink radio communications with devices (e.g., a controller for automatic execution of actuations). The device may include network interface circuitry 908 (also referred to as a network interface,) configured to provide communications with other devices (e.g., a controller for automatic execution of an actuation). The device may also include processing circuitry 903 (also referred to as a processor) coupled to the transceiver circuitry, memory circuitry 905 (also referred to as memory) coupled to the processing circuitry.

As discussed herein, operations of the device may be performed by processing circuitry 903, network interface 908, and/or transceiver 901. For example, processing circuitry 903 may control the system 900 to perform operations according to embodiments disclosed herein. Processing circuitry 903 also may control transceiver 901 to transmit downlink communications through transceiver 901 over a radio interface to one or more devices and/or to receive uplink communications through transceiver 901 from one or more devices over a radio interface. Similarly, processing circuitry 903 may control network interface 908 to transmit communications through network interface 908 to one or more devices and/or to receive communications through network interface from one or more devices. Moreover, modules may be stored in memory 905, and these modules may provide instructions so that when instructions of a module are executed by processing circuitry 903, processing circuitry 903 performs respective operations (e.g., operations discussed below with respect to example embodiments relating to devices). According to some embodiments, system 900 and/or an element(s)/function(s) thereof may be embodied as a virtual device/devices and/or a virtual machine/machines.

According to some other embodiments, a device may be implemented without a transceiver. In such embodiments, transmission to a wireless device may be initiated by the system 900 so that transmission to the wireless device is provided through a device including a transceiver (e.g., through a base-station). According to embodiments where the device includes a transceiver, initiating transmission may include transmitting through the transceiver.

FIG. 10 illustrates various functional modules stored in the memory 905 of the indoor installation recommendation system 900. In particular, the memory 905 may include a building-cell mapping module 912 that generates building topologies and associates the buildings to cells of a wireless communication network, network performance assessment module 914 that generates an assessment of network performance for each of the identified buildings, and a site ranking module 916 that ranks sites according to the need for indoor infrastructure deployment. Other modules may also be provided in the memory 905 to effect the operations described above.

Systems/methods for associating buildings with cells/sectors of a wireless communication network will now be described in more detail.

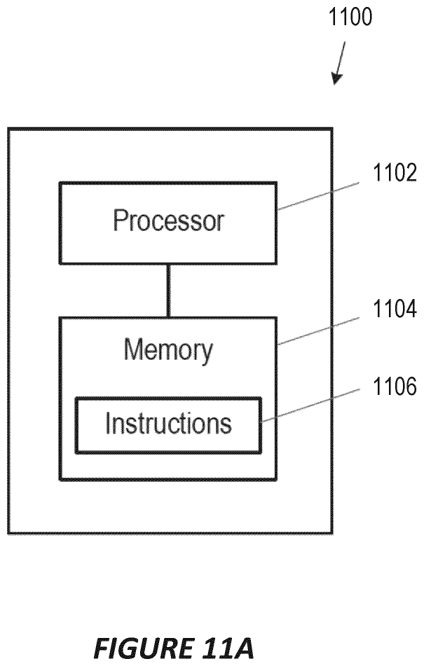

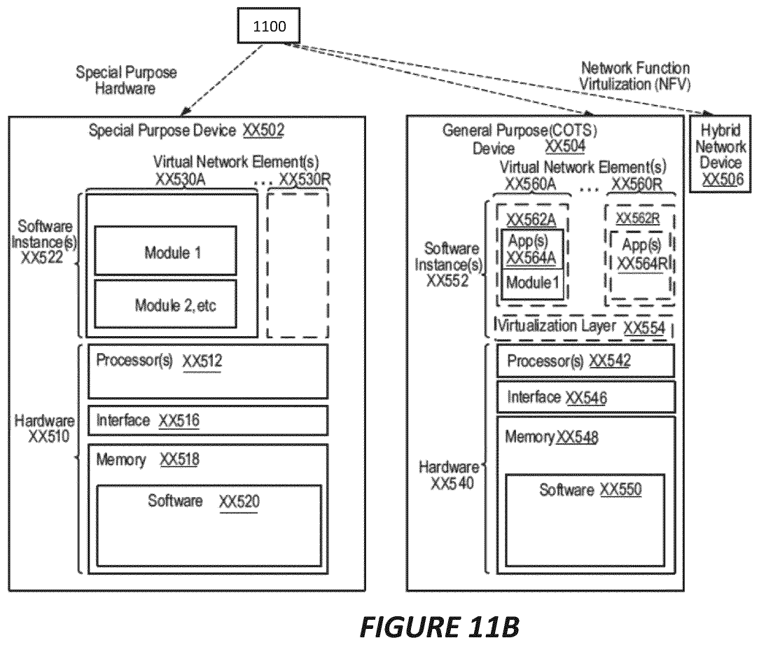

FIG. 11A illustrates a network node 1100 in a communications network according to some embodiments herein. Generally, the node 1100 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (Aps) (e.g., radio access points), base-stations (BSs) (e.g., radio base-stations, Node Bs, evolved Node Bs (eNBs) and NR NodeBs (gNBs)). Further examples of nodes include but are not limited to core network functions such as, for example, core network functions in a Fifth Generation Core network (5GC).

The node 1100 is configured (e.g. adapted, operative, or programmed) to perform any of the embodiments of the method 1200 as described below. It will be appreciated that the node 1100 may comprise one or more virtual machines running different software and/or processes. The node 1100 may therefore comprise one or more servers, switches and/or storage devices and/or may comprise cloud computing infrastructure or infrastructure configured to perform in a distributed manner, that runs the software and/or processes.

The node 1100 may comprise a processor (e.g. processing circuitry or logic) 1102. The processor 1102 may control the operation of the node 1100 in the manner described herein. The processor 1102 can comprise one or more processors, processing units, multi-core processors or modules that are configured or programmed to control the node 1100 in the manner described herein. In particular implementations, the processor 1102 can comprise a plurality of software and/or hardware modules that are each configured to perform, or are for performing, individual or multiple steps of the functionality of the node 1100 as described herein.

The node 1100 may comprise a memory 1104. In some embodiments, the memory 1104 of the node 1100 can be configured to store program code or instructions 1106 that can be executed by the processor 1102 of the node 1100 to perform the functionality described herein. Alternatively or in addition, the memory 1104 of the node 1100, can be configured to store any requests, resources, information, data, signals, or similar that are described herein. The processor 102 of the node 100 may be configured to control the memory 1104 of the node 100 to store any requests, resources, information, data, signals, or similar that are described herein.

It will be appreciated that the node 1100 may comprise other components in addition or alternatively to those indicated in FIG. 11A. For example, in some embodiments, the node 1100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of node 100 may be configured to control such a communications interface to transmit to and/or receive from other nodes or network functions requests, resources, information, data, signals, or similar.

Turning now to FIG. 11B, which shows some examples of how node 1100 may be implemented in certain embodiments of the described solution including: 1) a special-purpose network device XX502 that uses custom processing circuits such as application-specific integrated-circuits (ASICs) and a proprietary operating system (OS); and 2) a general purpose network device XX504 that uses common off-the-shelf (COTS) processors and a standard OS which has been configured to provide one or more of the features or functions disclosed herein.

Special-purpose network device XX502 includes hardware XX510 comprising processor(s) XX512, and interface XX516, as well as memory XX518 having stored therein software XX520. In one embodiment, the software XX520 implements modules to perform the method 1200 described below. During operation, the software XX520 may be executed by the hardware XX510 to instantiate a set of one or more software instance(s) XX522. Each of the software instance(s) XX522, and that part of the hardware XX510 that executes that software instance (be it hardware dedicated to that software instance, hardware in which a portion of available physical resources (e.g., a processor core) is used, and/or time slices of hardware temporally shared by that software instance with others of the software instance(s) XX522), form a separate virtual network element XX530A-R. Thus, in the case where there are multiple virtual network elements XX530A-R, each operates as one of the network devices from the preceding figures.

Returning to FIG. 11B, the example general purpose network device XX504 includes hardware XX540 comprising a set of one or more processor(s) XX542 (which are often COTS processors) and interface XX546, as well as memory XX548 having stored therein software XX550. During operation, the processor(s) XX542 execute the software XX550 to instantiate one or more sets of one or more applications XX564A-R. While certain embodiments do not implement virtualization, alternative embodiments may use different forms of virtualization. For example, in certain alternative embodiments virtualization layer XX554 represents the kernel of an operating system (or a shim executing on a base operating system) that allows for the creation of multiple instances XX562A-R called software containers that may each be used to execute one (or more) of the sets of applications XX564A-R. In this embodiment, software containers XX562A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer XX554 may represent a hypervisor (sometimes referred to as a virtual machine monitor (VMM)) or a hypervisor executing on top of a host operating system; and each of the sets of applications XX564A-R may run on top of a guest operating system within an instance XX562A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware XX540, directly on a hypervisor (in which case the unikernel is sometimes described as running within a LibOS virtual machine), or in a software container, embodiments can be implemented fully with unikernels running directly on a hypervisor represented by virtualization layer XX554, unikernels running within software containers represented by instances XX562A-R, or as a combination of unikernels and the above-described techniques (e.g., unikernels and virtual machines both run directly on a hypervisor, unikernels and sets of applications that are run in different software containers).

The instantiation of the one or more sets of one or more applications XX564A-R, as well as virtualization if implemented are collectively referred to as software instance(s) XX552. Each set of applications XX564A-R, corresponding virtualization construct (e.g., instance XX562A-R) if implemented, and that part of the hardware XX540 that executes them (be it hardware dedicated to that execution and/or time slices of hardware temporally shared by software containers XX562A-R), forms a separate virtual network element(s) XX560A-R. The virtual network element(s) XX560A-R perform similar functionality to the virtual network element(s) XX530A-R. This virtualization of the hardware XX540 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) XX562A-R differently. While embodiments of the invention are illustrated with each instance XX562A-R corresponding to one VNE XX560A-R, alternative embodiments may implement this correspondence at a finer level granularity; it should be understood that the techniques described herein with reference to a correspondence of instances XX562A-R to VNEs also apply to embodiments where such a finer level of granularity and/or unikernels are used.

The third exemplary ND implementation in FIG. 11B is a hybrid network device XX506, which includes both custom ASICs/proprietary OS and COTS processors/standard OS in a single node or a single card within a node. In certain embodiments of such a hybrid network device, a platform virtual machine (VM), such as a VM that that implements the functionality of the special-purpose network device XX502, could provide for para-virtualization to the hardware present in the hybrid network device XX506.

Turning back to FIG. 11A, briefly, in one embodiment, the node 1100 is configured to: i) obtain first geo-located signal strength measurements from first devices connected to a first cell in the communications network; ii) obtain a first location, l, of a first antenna associated with the first cell; iii) provide the first geo-located signal strength measurements and the first location as input to a model trained using a machine learning process, wherein the model is trained to predict azimuth of a cell from: geo-located signal strength measurements of devices connected to the respective cell and a location of an antenna associated with the respective cell; and iv) receive as output from the model, a predicted azimuth of the first cell.

Coverage, or access to the communications network is provided by antennae, e.g. radio antennae. A cellular base-station (otherwise referred to herein as a base-station) may refer to any equipment or hardware configured to, or capable of providing radio access to the communications network. Examples of base-stations (BSs) include but are not limited to e.g., radio base-stations, Node Bs, evolved Node Bs (eNBs) and NR NodeBs (gNBs).

Each base-station has one or more antennae. Each antenna (or antenna array) is associated with (e.g. serves) one or more cells. Each cell corresponds to an individual radio coverage area provided by an antenna (or antenna array) in a particular frequency band. In general, cells may be overlapping. For example, cells may be overlapped so as to form contiguous coverage.

The direction in which an antenna points is known as the cell azimuth. Cell/Antenna Azimuth, as used herein, refers to the clockwise antenna direction on the horizontal axis compared to north. The range of cell/antenna azimuth values is between 0-360. The cell azimuth bisects the cell (e.g. lies in a direction through the center of the cell from the antenna).

Thus, the first cell corresponds to a first coverage area served by a first antenna. The first antenna may be comprised, for example in an outdoor sectorized base-station for a 4G or 5G network.

As used herein, a “sector” may be a base service area, for example, a sector may represent the smallest service area where users are served in a geographical region by a cell. A sector is generally a coverage area associated with one cell, or the coverage area representing the union of the coverage areas of two or more cells. A sector may be limited by geographical boundaries, licensed amount of frequency spectrum, radio propagation conditions, and can be associated with a geographic area characterized by a set of sociodemographic (population density, age groups etc.) and economic (level of demand for certain SLA, QoS etc.) characteristics that can evolve over time. A sector can be served by one cell, that can be provided by more than one Communications Service Provider (CSP). However, different cells with different frequencies can provide coverage to the same area.

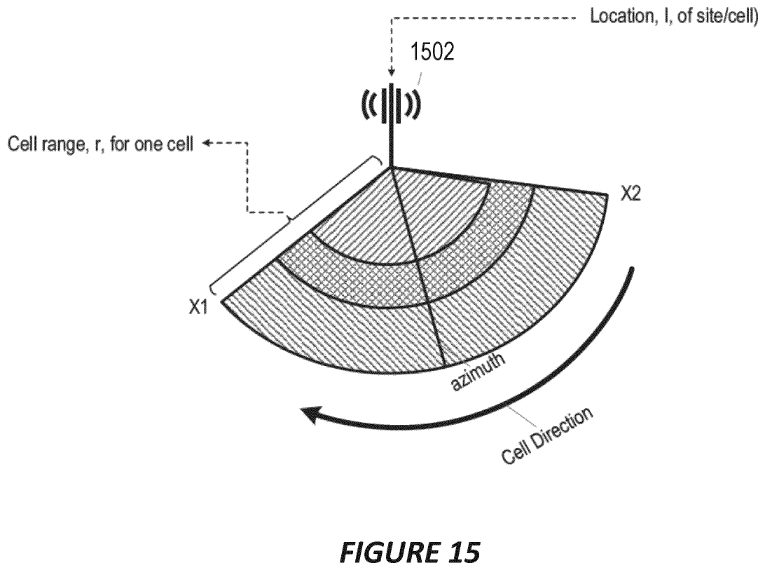

For a cell in a sectorized base-station, a sector can be characterized by geographic position of the antenna (latitude, longitude), cell range, and centered on its antenna azimuth. Antenna downtilt can have an impact on sector shape calculations. However, cell range, in this context, refers to the outreach of signal range that is often affected by maximum cell range (depends on HW product and technology supported), and antenna downtilt. Traditionally, antenna elements are generally co-located in the same site, but have different characteristics such as cell range and frequency. Hence, a set of cells can be allocated in same area which lead to overlapped shapes of different sectors. In 4G and 5G mobile networks, the most common setup for outdoor networks is sectorized base-station with three sectors for the same frequency, where 360-degree site coverage layout is divided horizontally into 120-degree coverage areas for the same frequency. FIG. 15 illustrates an example of a sector shape.

FIG. 15 shows a cellular basestation 1502 at a location, l. The sector area associated with one cell can be calculated using antenna location (latitude, longitude), cell azimuth, and cell range.

The term device (otherwise referred to herein as a wireless device or User Equipment, (UE) is a device capable, configured, arranged and/or operable to communicate wirelessly with network nodes and/or other wireless devices. Examples of devices include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a device may represent a machine or other device that performs monitoring and/or measurements, and transmits the results of such monitoring and/or measurements to another UE and/or a network node. The device may in this case be a machine-to-machine (M2M) device, which may in a 3GPP context be referred to as an MTC device. As one particular example, the a device may implement the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A device 1700 as described above may represent the endpoint of a wireless connection, in which case the device may be referred to as a wireless terminal. Furthermore, a device as described above may be mobile, in which case it may also be referred to as a mobile device or a mobile terminal.

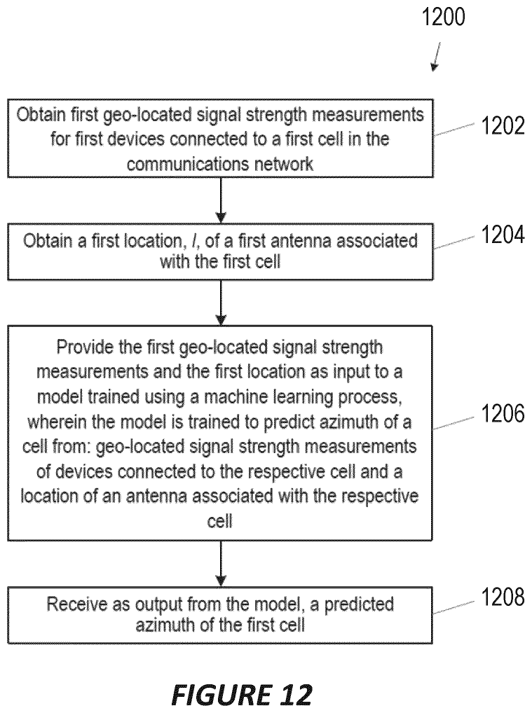

Turning now to FIG. 12 which shows a method 1200 in a node in a communications network. The method 1200 may be performed by a node such as the node 1100 described above. Briefly, in a first step 1202 the method 1200 comprises i) obtaining first geo-located signal strength measurements from first devices connected to a first cell in the communications network. In a second step 1204 the method comprises: ii) obtaining a first location, l, of a first antenna associated with the first cell. In a third step 1206 the method comprises: iii) providing the first geo-located signal strength measurements and the first location as input to a model trained using a machine learning process, wherein the model is trained to predict azimuth of a cell from: geo-located signal strength measurements of devices connected to the respective cell and a location of an antenna associated with the respective cell. In a fourth step 1208 the method comprises and iv) receive as output from the model, a predicted azimuth of the first cell.

In step 1202 of the method 1200, first geo-located signal strength measurements are obtained for (or from) first devices connected to a first cell in the communications network. In other words, a first plurality of geo-located signal strength measurements are obtained, as measured by a first plurality of devices connected to the first cell. The first geo-located signal strength measurements may comprise signal strength measurements and corresponding locations at which the signal strength was measured, in other words, [location, signal strength] tuples. In some embodiments, the first geo-located signal strength measurements comprise a list of [location, signal strength] tuples obtained for the first devices.

Geo-located signal strength measurements may be Reference Signal Received Power, RSRP, Reference Signal Received Quality, RSRQ, Signal to Interference & Noise Ratio, SINR, measurements and/or any other type of measurement that may be used to indicate signal strength of the cell.

In some embodiments, the first geo-located signal strength measurements are obtained from the first devices as part of the normal signal strength reporting procedures. Such data may be considered passive network data. In other embodiments, dedicated measurements may be made, for example, step 1202 of the method 1200 may comprise initiating requests to the first devices connected to the first cell to make signal strength measurements and the resulting measurements may be reported back to the node 1100.

In some embodiments, the locations of the devices (at which the signal strength measurements were made) are converted into unique geographic identifiers corresponding to a region on the Earth in which a respective device was located when a respective signal strength measurement was made. For example, the locations may be geo-hashed. Put another way, an Index may be obtained for each device. An example method is described in the paper by Sahr, K., White, D., & Kimerling, A. J. (2003) entitled: “Geodesic discrete global grid systems”; Cartography and Geographic Information Science, 30(2), 121-134. In some embodiments, the H3 method from Sahr et al. (2003) is used to index (latitude, longitude) to spatial hexagon and generate the geo index (geo hash). The framework comprises a global grid system that is suitable for analyzing large spatial data sets, by partitioning areas of the Earth into identifiable grid tiles. The resolution/hexagon size reflects the size of homogenous hexagons used to divide the earth. The choice of hexagon size can be fine-tuned during the training process.

In step 1204, a first location, l, of a first antenna associated with the first cell is obtained. The first antenna may be part of a first telecom base-station. In other words, the first antenna may be a first telecom base-station antenna associated with the cell. The first antenna is associated with the first cell. In other words, the first antenna generates or provides the first cell.

The first location of the first antenna may be given as a pair of co-ordinates, e.g. as a latitude and longitude. This may be obtained, for example from site configuration data (e.g. network site inventory data) for the antenna associated with the first cell. Example site configuration data is given in Table 1.1.

TABLE 1.1
Example of cell configuration attributes

| Hashed | Cell/Antenna | DL Channel | UL Channel | Frequency | | Cell |
|---|---|---|---|---|---|---|
| Cell Id | Location | Bandwidth | Bandwidth | Band | Azimuth | Range |
| 123AT | Anonymized cell | 2000 | 2000 | 7 | 45 | 1000 |
| | latitude/longitude | | | | | |

In some embodiments, step 1204 may comprise converting the first location (e.g expressed as co-ordinates) into a unique geographic identifier. In other words, the latitude and longitude of the antenna maybe geo-hashed. The first location may be geo-hashed in the same manner (e.g., using the same process) as was used to geo-hash the locations of the first devices in step 1202.

In step 1206 the method comprises providing the first geo-located signal strength measurements and l (the first location of the first antenna associated with the first cell) as input to a model trained using a machine learning process. The model has been trained to predict azimuth of a cell from: geo-located signal strength measurements of devices connected to the respective cell and a location of an antenna associated with the respective cell.

In other words, the model has been trained to take as input geo-located signal strength measurements of devices connected to a respective cell and a location of an antenna associated with the respective cell. Based on the inputs, the model is trained to output azimuth of the respective cell.

In step 1208, the method 1200 comprises receiving as output from the model, a predicted azimuth of the first cell. The predicted azimuth of the first cell is predicted based on the input data (e.g. the first geo-located signal strength measurements and l (the first location of the first antenna associated with the first cell). In other words, the model processes the input data to predict the azimuth of the first cell and provides the predicted azimuth of the first cell as output.

As used herein, a model trained using a machine learning process may alternatively be referred to as a machine learning model. The skilled person will be familiar with machine learning (ML) and machine learning processes for use in training machine learning models. ML is an approach that allows a programmer to implement a program by finding patterns in data samples. A program or model that is obtained through Machine Learning is called a Machine Learning model. ML models can be trained to perform tasks such as classification (e.g., label prediction) or regression (e.g., prediction of a value) tasks. A dataset of samples used to train the model is also known as a training set. Training data comprises training examples (each training example comprising an example input and a corresponding “correct” ground truth output). The model is trained on the training data, using the machine learning process.

A machine learning process comprises a procedure that is run on the training data to create the machine learning model. The machine learning process comprises procedures and/or instructions through which training data, may be processed or used in a training process to generate the machine learning model. The machine learning process learns from the training data. For example, the process may be used to determine how one set of parameters in the training data (input parameters of the model) are correlated with another set of parameters in the training data (output parameters of the model). The machine learning process may be used to fit the model to the training data.

Examples of machine learning processes include but are not limited to, e.g. algorithms for classification, such as k-nearest neighbors, algorithms for regression, such as linear regression or logistic regression, and algorithms for clustering, such as k-means.

The model, or machine learning model, may comprise both data and procedures for how to use the data to e.g. make the predictions described herein. The model is what is output from the machine learning (e.g. training) process, e.g. a collection of rules or data processing steps that can be performed on the input data in order to produce the output. As such, the model may comprise e.g. rules, numbers, and any other algorithm-specific data structures or architecture required to e.g. make predictions.

Different types of models take different forms. Some examples of machine learning processes and models that may be used herein include, but are not limited to: linear regression processes that produce models comprising a vector of coefficients (data) the values of which are learnt through training; decision tree processes that produce models comprising trees of if/then statements (e.g. rules) comprising learnt values; and neural network models comprising a graph structure with vectors or matrices of weights and biases with specific values, the values of which are learnt using machine learning processes such as backpropagation and gradient descent.

The skilled person will appreciate that many different model types may be trained to predict azimuth from geo-located signal strength measurements and cell antenna location. For example, the model may be a decision tree model, such as a gradient boosted decision tree. In some embodiments the model is a Random Forest model or an XGBoost model.

XGBoost is an implementation of a gradient boosted decision tree, and is described in the paper by T. Chen and C. Guestrin, entitled: “XGBoost: A scalable tree boosting system,” in Proc. 22nd ACM SIGKDD Int. Conf. Knowl. Discovery Data Mining, 2016, pp. 785-794. XGBoost is optimized to make predictions from structured or tabular data and as such is well suited to predicting azimuth from a list of geo-located signal strength measurements.

Although particular model types have been indicated herein, it will be appreciated that other types of model may equally be used, for example, the model may be a neural network model or any other model that can be trained to predict cell azimuth in the manner described herein.

The inputs to the model are geo-located signal strength measurements of devices connected to the respective cell and the location of an antenna associated with (e.g. serving) the respective cell. The geo-located signal strength measurements may comprise: at least one of: Reference Signal Received Power (RSRP), Reference Signal Received Quality (RSRQ), and/or Signal to Interference & Noise Ratio (SINR) measurements. The locations of the devices may be expressed in terms of a unique geographic identifier corresponding to a region on the Earth in which a respective device was located when a respective signal strength measurement was made. In other words, the cell/antenna location and/or the locations of the devices may be geo-hashed.

The model may be trained to take further inputs, such as, for example, distances between the devices and the location of the first antenna; and/or bearings of the devices with respect to the first location of the first antenna. A such, the method 1200 may further comprise, determining first distances between the location l and the first devices and/or determining bearings of the first devices with respect to the location of the first cell and providing these as input to the model.

In some embodiments, the model takes as input: Location of first cell, and a list of [Location, RSRQ, RSRP, SINR/SNR, Cell-measurement Bearing, Cell-measurement Distance] for each device of the plurality of devices.

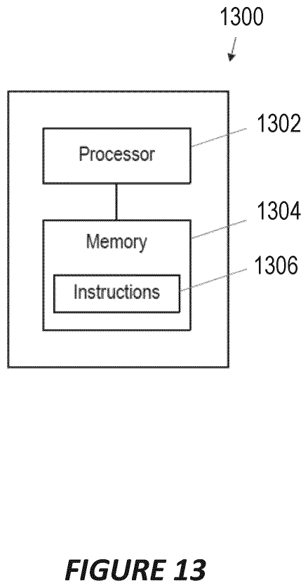

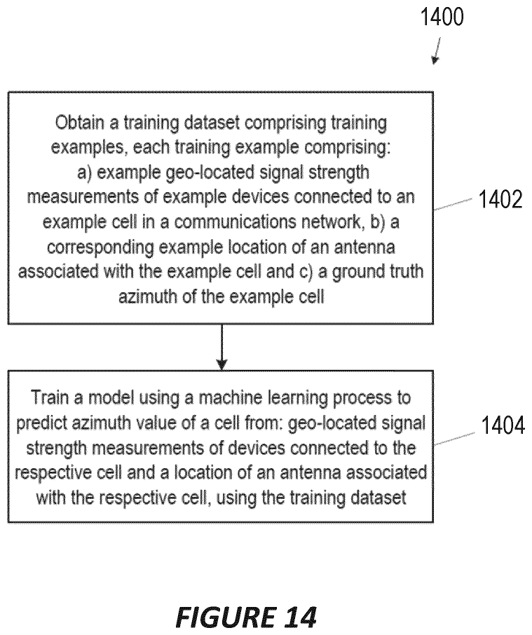

A full description of the manner in which it is trained is given below with respect to FIGS. 13 and 14 and the detail therein will be understood to apply equally to trained model in the method 1200.

Turning back to the method 1200, the predicted azimuth of the first cell obtained in step 1208 can be used in a wide range of tasks. As an example, the predicted azimuth may be used to verify site inventory data for the first cell. For example, the method 1200 may further comprise comparing the predicted azimuth of the first cell to a reported azimuth for the first cell obtained from network site inventory data to determine whether the network site inventory data is correct.

In some embodiments, steps i), ii), iii) and iv) may be repeated (e.g. at regular time intervals or following significant events, such as maintenance or weather incidents) in order to monitor the predicted azimuth of the first cell over time. As such, the predictions, or drift in the predictions may be used in maintenance planning and/or to initiate Engineering works.

In other embodiments, the predicted azimuth of the first cell may be used to infer other shape features of the cell or a sector associated with the cell.

For example, cell range may be inferred from the maximum distance at which a device is connected to the cell. As such, in some embodiments, the method 1200 may further comprise determining distances between positions of the first devices and the first location, l, and estimating a range, r, of the first cell from a maximum of the determined distances.

The angular extent of a cell (e.g. the angle covered or spanned by the cell) depends on the site coverage layout, which is typically divided horizontally into 60, 90, or 120-degree sectors. Hence, the number of sectors in the site can be inferred from the number of cells with the same frequency.

Thus, the method 1200 may further comprise obtaining a number of cells, n, being served by the first antenna with the same frequency as the first cell. This may be obtained, for example, from site inventory data. An angular extent of the first cell may then be determined by dividing 360 degrees by n.

The outer edges of a geographic coverage area of the first cell can then be determined from the predicted azimuth of the first cell and the angular extent. This can be performed, for example, by determining a first point, x1 (as illustrated in FIG. 15), wherein the first point is determined at a distance r from the first location of the first antenna, and at an angle of +360 degrees/2n from the azimuth. A second point, x2 (as illustrated in FIG. 15), can be determined wherein the second point is determined at a distance r from the first location of the first antenna, and at an angle of −360 degrees/2n from the azimuth. The first point and the second point represent a first outer extent of the first cell and a second outer extent of the first cell respectively.

The geographic coverage area of the first cell can then be determined from the points, l, x1, and x2. For example, the geographic coverage area may be determined as an area bounded by: a first straight line between x1 and l; a second straight line between x2 and l; and a third line between x1 and x2.

As noted above, typically, for outdoor base-stations, a 360-degree site coverage layout is commonly divided horizontally into 120-degree sectors with the same frequency. However, the boundaries of adjacent sectors need to have a slight overlap to enable a smooth handover for floating UEs. In addition, the inconsistent nature of the radio propagation and the attenuation of electromagnetic waves with respect to distance, diverse geographic distribution and weather conditions. In order to analyze and optimize coverage with respect to network configuration, sectors are often represented in different shapes. In some embodiments herein, the site coverage area is represented as a circle with the base-station at the centre, and each sector coverage area as pie-shape area. However, coverage regions can also be represented using other shapes such squares, hexagons, rectangles, or irregular shapes. Using the predicted azimuth for the first cell and the estimate range, the sector coverage shape can be represented using e.g. triangles or pie-shape sectors. The number of sectors (i.e., pie slices in coverage layout) depends on the number of cells with the same frequency.

In order to represent coverage area as pie-shape areas, the following steps may be performed to make the third line a curved line between x1 and x2:
Set number of points (n_points) that we need to draw in pie-shaped boundaries. E.g. 100,
Generate points (n_points) between x1 and x2 using the following formula. For each point degree pd between x1 & x2,

$$boundary Point = ( radius * cos ( convert\_degree \_to \_radian ( p d ) ) , radius * cos ( convert\_degree \_to \_radian ( p d ) ) ) .$$

Draw pie-shaped area connecting base-station location, x1, and boundary points (boundary_pointᵢ for i between 0 and n_points).

In order to represent coverage area as a rectangular area (e.g. where the third line is a straight line), the following step may be performed:
Draw a rectangular shape between base-station location, x1, x2.

Turning now to an example, in one embodiment, azimuth of the first cell is estimated using antenna physical information and geo-located signal measurements. The maximum possible distance between cell/antenna location and the location of the signal strength measurements is calculated. Signal strength measurement distance refers to the geographical distance between signal measurement's locations and cell/antenna location.

In order to calculate sector shape region (as illustrated in FIG. 15), the following values are estimated or calculated:
Estimate cell/antenna azimuth based on the method 1200 described above.
Estimate cell range based on the maximum possible distance.
Calculate number of sectors. A sector typically constitutes the “area” covered by many cells with different frequency bands. Typically, 360-degree site coverage layout is divided horizontally into 60, 90, or 120-degree sectors with the same frequency. Hence, number of sectors in the site can be inferred from the number of cells with the same frequency.
Antenna physical information (latitude, longitude). Based on this information, a geographic shape for each sector can be generated, where coverage area span between three points

Retrieve cell location from the associated with antenna location (Cell latitude, Cell longitude)
second point coordinates, which can be calculated using (Cell latitude, Cell longitude) given a bearing=(estimated azimuth−360/2*number of sectors) and a distance=cell range.
third point coordinates, which can be calculated using (Cell latitude, Cell longitude) given a bearing=(estimated azimuth+360/2*number of sectors) and a distance=cell range.

In order to represent coverage area as pie-shape or rectangular areas, the steps outlined above may be performed to make the third line a curved line between x1 and x2.

In this way, a sector shape can be inferred, which can be used in various tasks such as telecom network maintenance, site planning, base-station configuration optimization, network coverage analysis and network coverage planning.

Turning now to other embodiments, the following embodiments relate to example methods of training the model used in the method 1200 described above. FIG. 13, in some embodiments, a node 1300 may be used to train the model. The node 1300 may be configured to perform the method 1400 described below. The node 1300 may comprise a processor 1302, and a memory 1304. The memory 1304 may comprise a set of instructions 1306 that when executed by the processor 1302 cause the processor to perform the functionality described herein. Processors, memory and instructions were all described above with respect to the node 1100 and the detail therein will be understood to apply equally to the node 1300.

Examples of nodes were given above with respect to the node 1100 and the examples therein will be appreciated to apply equally to the node 1300. For example, the node 1300 may be an access point (APs) (e.g., radio access point), base-station (BSs) (e.g., radio base-station, Node B, evolved Node B (eNB) and NR NodeB (gNB)). Further examples of nodes include but are not limited to core network functions such as, for example, core network functions in a Fifth Generation Core network (5GC). In some embodiments, the node 1300 may be a node in the cloud.

The node 1300 is configured to obtain a training dataset comprising training examples, each training example comprising: a) example geo-located signal strength measurements of example devices connected to an example cell in a communications network, b) a corresponding example location of an antenna associated with the example cell and c) a ground truth azimuth of the example cell; and train a model using a machine learning process to predict azimuth value of a cell from: geo-located signal strength measurements of devices connected to the respective cell and a location of an antenna associated with the respective cell, using the training dataset.

FIG. 14 shows a method 1400 in a node in a communications network according to some embodiments, herein. The method 1400 may be performed by the node 1300 described above, or the node 1100 described above. In other words, the training of the model (using the method 1400) and the inference of the model (using the method 1200) may be performed by the same node, or by different nodes in the communications network.

Briefly, the method 1400 comprises, in a first step 1402, obtaining a training dataset comprising training examples, each training example comprising: a) example geo-located signal strength measurements of example devices connected to an example cell in a communications network, b) a corresponding example location of an antenna associated with the example cell and c) a ground truth azimuth of the example cell. In a step 1404, the method comprises training a model using a machine learning process to predict azimuth value of a cell from: geo-located signal strength measurements of devices connected to the respective cell and a location of an antenna associated with the respective cell, using the training dataset.

Considering a cell as a “pie shape” or wedge, as noted above, the azimuth is on the axis of symmetry of sector area shape. The propagation of electromagnetic waves attenuates with respect to distance, so signal strength is correlated with both distance and azimuth line. The signal strength tails off either side of the azimuth line. Thus, signal strength is correlated to cell azimuth and as such, a plurality of signal strength values, obtained at different locations in the cell can be used to predict the location of the cell azimuth.

The training dataset may be compiled of data relating to example cells with known cell direction e.g. known azimuth values. Cell range and/or cell shape may also be known for the example cells in the training dataset. A threshold density of training examples may be introduced, in order to eliminate cases where there are too few samples to accurately estimate cell azimuth. In such cases, the results can lead to biased results. The choice of a threshold can be fine-tuned. However, by considering a long historic interval, these cases can be avoided. It is noted that it can be more difficult to collect sufficient data for newly deployed sites (e.g. when mobile operator starts rolling out a new 5G site, in ML literature, this is often referred to as a “Cold Start problem” as it relates to an estimation a new event or phenomena).

The skilled person will appreciate that the accuracy of the model will be dependent on the range and variety of training data provided to the model in the training phase. Generally, cells from different regions may be used as training data in order to assess the scalability of the method. For the most complete training dataset, data from all cells for each mobile operator in the country may be accrued. However it will be appreciated that a model may be trained on small datasets. As described below, a model may be trained with good accuracy on 6 weeks' work of geo-located signal strength measurements from three sites.

The example geo-located signal strength measurements in the training data set can be acquired from Drive Tests (CTR) or can be acquired from third-parties that benchmark signal strength and network coverage globally. The raw data can be anonymized to preserve privacy. Each data point encompasses a set of attributes such as global cell identifier, signal strength measurement values, timestamp of observation, and the longitude and latitude information of samples. Table 1.2 shows an example of geo-located signal strength measurements.

TABLE 1.2
Example of geo-located signal strength measurements

| | Hashed | | | | | | | |
|---|---|---|---|---|---|---|---|---|
| Hashed | Sample | Measurement | | | | | | |
| Cell ID | ID | Location | RSRQ | RSRP | SINR/SNR | Technology | MCC | MNC |
| 123AT | 123AT834 | Anonymized | −9 | −93 | 3 | LTE/4G | Anon | Anon |

The example locations of the example devices may be converted into a unique geographic identifier corresponding to a region on the Earth in which a respective example device was located when a respective signal strength measurement was made. E.g. the example device locations may be geo-hashed, as described above with respect to the method 1200.

The antenna location and ground truth azimuth values for each example cell may be obtained from network site inventory data. Network site inventory data is a dataset comprising information about site physical location and (a selected set of) cell configuration attributes, e.g. obtained when the cell was configured. Example network site inventory data is given in Table 1.1.

The location (latitude, longitude) of the example cells in the training data may be converted into a unique geographic identifier corresponding to a region on the Earth in which the example cell is located. In other words, the model may be trained to take a geohash of cell/antenna location as input (e.g. rather than the location in coordinate pairs form). Geo-hashing was described above and the detail therein will be understood to apply equally to the method 1400.

It is noted that the efficiency training of the model is improved when geo-hashed locations are used, compared to latitude and longitude value pairs, as each geo-hash coordinate directly corresponds to a single categorical geographical location, whereas latitude and longitude are co-dependent continuous variables, from which location can only be obtained in combination.

In some embodiments, the model is further trained to take bearing of each device with respect to the cell antenna and/or the distance between the cell antenna and each device as input. A such, the method 1400 may further comprise, for each training example, determining distances between the example devices and the example location of an antenna associated with the respective example cell; and/or determining bearings of the example devices with respect to the location of the antenna associated with the respective example cell. The model may further take as input the distances and/or bearings and may take the distances and bearings into account when predicting cell azimuth.

The experiments described below showed that using the distances and/or bearings helps enhance the azimuth estimation. This may be because points can be clustered or grouped in a place with respect to the location of base-station. The group of measurements share approximately similar bearing. At the other hand, the propagation of the signal and signal strength is correlated with distance and location with respect of azimuth line.

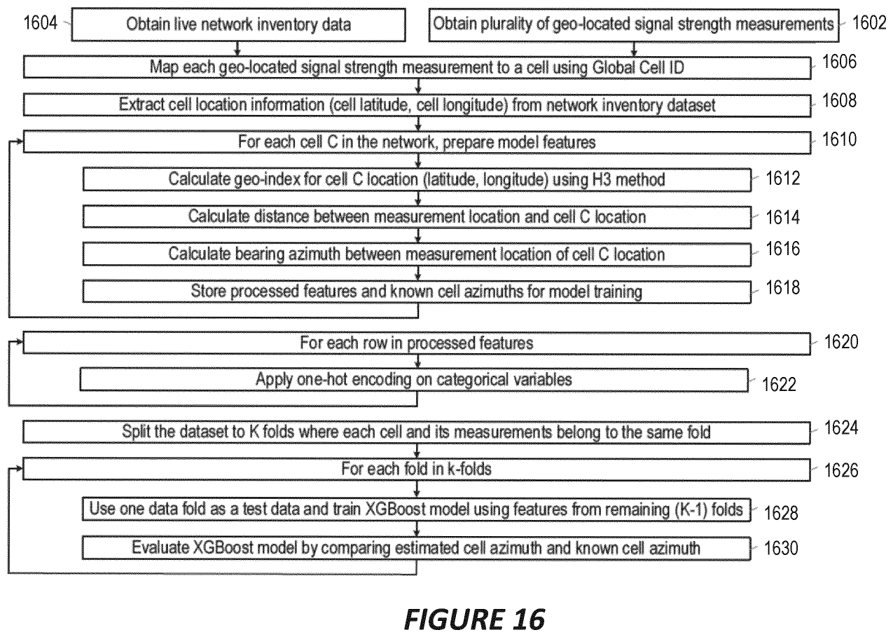

In one example embodiment, training proceeds according to FIG. 16. In this embodiment, an XGBoost model is used, however it will be appreciated that the steps in FIG. 16 could equally be applied to the training of other types of model.

In step 1602: the method 1600 comprises obtaining a plurality of example geo-located signal strength measurements for different example cells (according to step 1402 of the method 1400 described above).

In step 1604: Live network inventory data is obtained to obtain the corresponding example locations of the antennae associated with each example cell and the ground truth ground truth azimuth of the example cell.

In step 1606: Each geo-located signal strength measurement is mapped (e.g. attributed to, or associated with) an example cell using e.g. the field “Global Cell ID”.

In step 1608: cell/antenna location and antenna direction (e.g. cell azimuth) are extracted from network inventory data. The cell/antenna location is used to calculate distance between geolocated signal strength measurement and the cell. cell/antenna direction is used as ground truth (e.g. example correct output) and is only needed during training of the model and validation of the results. This is the feature that the model is trained to predict from the input parameters.

Once the measurements are grouped by each cell in the network (in step 1606), the following data processing tasks are performed:
1612: Index cell/antenna location: the H3 method (as described in the paper by Sahr & Kimerling (2003) cited above) is used to index cell/antenna location (latitude, longitude) to a spatial hexagon and generate geo index (geo hash). The hexagon resolution can be fine-tuned, depending on country size, and density of deployed base-stations. In this example, resolution is used. It will be appreciated that other geo-hashing methods (with other resolutions) may equally be used. For example, the spatial resolution chosen may depend on the size of the cells under consideration.
1614: Calculate geographic distance between sample location and cell/antenna location. This can be, for example, a Euclidean distance.
1616: Calculate “bearing azimuth” between measurement location and cell/antenna location for each example device. This is also referred to herein as determining bearings of the example devices with respect to the example cell/antenna location. Bearing azimuth, in this context, refers to the angular direction of signal measurement's location corresponding to the cell/antenna location. The values can vary between 0 and 360.

Signal strength values such RSRQ (Reference Signal Received Quality), RSRP (Reference Signal Received Power), RSSI (Received Signal Strength Indicator), and SINR/SNR (Signal-to-noise-ratio of the given signal) are also extracted and in step 1618, the features above are stored for model training.

In the training phase, the constructed dataset which includes model features and known (e.g. ground-truth) example cell/antenna azimuth can be divided into different folds (in step 1624) where one fold is used as a test/validation dataset, and the remaining (k−1) folds are used to train the model to estimate cell/antenna azimuth (in steps 1626 and 1628).

The output of the model (e.g. the output data type) is an estimated azimuth value, that can vary between 0-360 degrees.

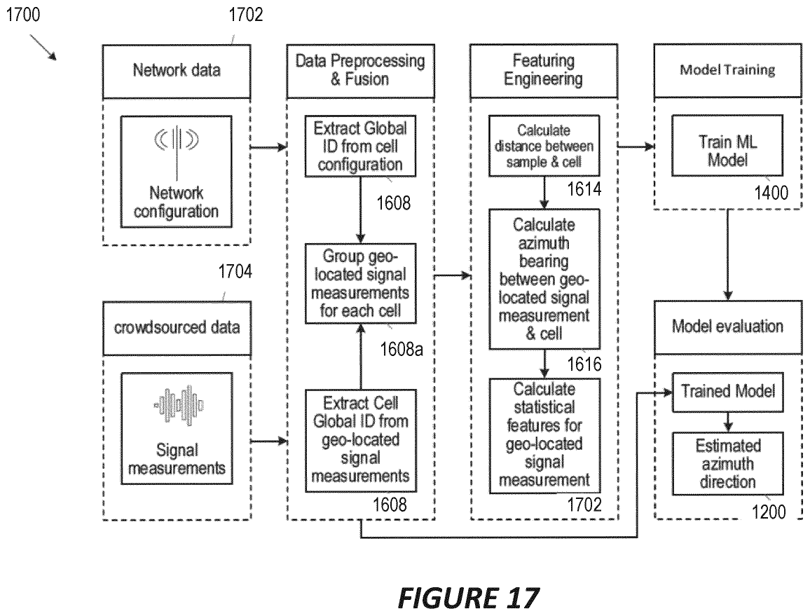

Turning now to FIG. 17 which shows a system 1700 according to some embodiments herein. In this embodiment, network data 1702, (comprising cell site and antenna location) is collected from network configuration data. Geo-located signal strength measurements 1704 are obtained for devices. The collected data is passive or crowd sourced data. A data Pre-processing and fusion module extracts Global ID from cell configuration data and the geo-located signal measurements (according to step 1608 described above) and groups the geo-located signal measurements according to cell in step 1608a.

A feature engineering Block calculates the distance 1614 between each device and the location of the cell associated with it. The bearings of the devices with respect to the associated cell/antenna location are determined 1702. Any other statistical features for geolocated signal measurement are determined in 1702. The data from steps 1614, 1616 and 1702 can then be used as training data with which to train the model according to the method 1400 described above.

Alternatively, the output from steps 1608a (geo-located signal strength measurements for an individual cell and cell antenna location) can be fed into the trained model and used to estimate azimuth direction according to the method 1200 described above. This, in this manner, the system 1700 can be used both to train and use the model.

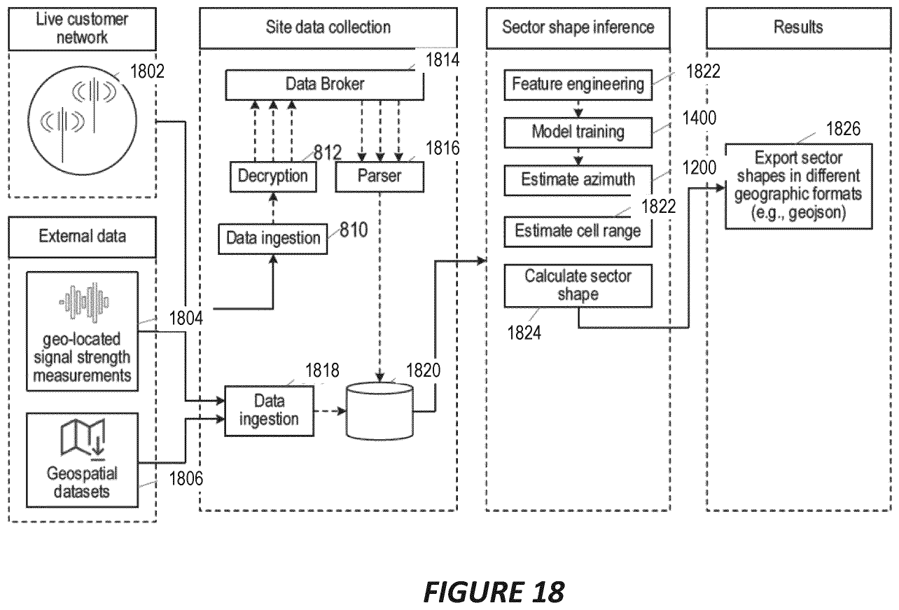

FIG. 18 puts the system 1700 into the context of the wider communications network. In FIG. 18, live device data 1802 is obtained from the lie customer network and fed into a site data collection module. The site data collection module ingests the data 1810, decrypts it 1812 and it is then sent through a data broker 1814 and parser 1816 before being sent to a database 1820.

External data comprising geo-located signal strength measurements 1804 and geospatial datasets 1806 are also collected, passed through a data ingestion module 1818 and stored in database 1820. The data in database 1820 is used to infer sector shape according to the principles described herein. For example, it may be pre-processed 1822 to obtain the features such as distances between a respective device and the antenna associated with the device that is serving the respective device, and bearings between the cell antenna and the respective devices. The processed data can be used as training data to train a model using the method 1400 described above and/or the trained model can be used to estimate azimuth of a new cell using the method 1200 described above. Cell range 1822 can be estimated as described above, and the predicted azimuth and cell range can be used to calculate sector shape 1825. The determined sector shapes can then be exported in 1826 for use in e.g. planning and/or monitoring processes. Estimating cell range and sector shape was described above with respect to the method 1200 and the detail therein will be understood to apply equally to the system shown in FIG. 18.

There is thus provided methods and nodes that can be used to predict azimuth of a cell, using geo-located signal measurements. These can be collected in a passive manner. As has been shown herein, the volume of passive data collected in this manner can be leveraged to train machine learning models to predict cell azimuth with high levels of accuracy.

Turning to other embodiments, there is also provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run15 time. The main program contains at least one call to at least one of the sub-routines. The subroutines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of managing a wireless communication network, comprising:
obtaining network configuration and network performance data for the wireless communication network;
obtaining urban infrastructure data for a geographic area of interest;
extracting a plurality of building topologies of buildings in the geographic area of interest from the urban infrastructure data;
associating respective ones of the building topologies with one or more cells of the wireless communication network;
assessing performance of the wireless communication network at the plurality of buildings based on the network configuration and performance data; and
for each of the buildings, generating a benefit metric indicative of a potential benefit associated with upgrading and/or deploying wireless network equipment in the wireless communication network based on the assessed performance of the wireless communication network at the building and a topological characteristic of the building obtained from plurality of building topologies.

2. The method of claim 1, further comprising ranking the buildings according to the benefit metric.

3. The method of claim 1, further comprising: categorizing the buildings as indoor or outdoor locations, wherein generating the metric comprises generating the metric for buildings categorized as indoor locations.

4. The method of claim 1, wherein the urban infrastructure data comprises satellite imagery data, wherein extracting the plurality of building topologies comprises applying a machine learning model to the satellite imagery data to obtain the plurality of building topologies.

5. The method of claim 1, wherein assessing the performance of the wireless communication network comprises assessing key performance indicators of the wireless communication network relating to traffic volume, accessibility, resource utilization, energy performance and/or path loss of the wireless communication network relative to the plurality of building topologies.

6. The method of claim 1, wherein associating respective ones of the building topologies with one or more cells of the wireless communication network comprises:
generating a map of a geographic coverage of a cell of the wireless communication network; and
determining an overlap of the plurality of building topologies with the geographic coverage of the cell of the wireless communication network.

7. The method of claim 1, wherein associating respective ones of the building topologies with one or more cells of the wireless communication network comprises associating respective ones of the building topologies with one or more sectors of one or more cells of the wireless communication network.

8. The method of claim 1, wherein the network performance data comprises key performance indicators, KPIs, that measure network customer usage data and network demand.

9. The method of claim 1, wherein assessing performance of the wireless communication network within the one or more cells takes into one or more of: throughput, quality of service (QoS), quality of experience (QoE), dropped calls, dropped packets, system bandwidth, modulation and coding schemes (MCS) used in a cell/sector, reference signal received power (RSRP), and reference signal received quality (RSRQ).

10. (canceled)

11. The method of claim 1, wherein generating the benefit metric comprises:
obtaining input metrics for a plurality of factors associated with the building;
normalizing the input metrics; and
combining the input metrics to obtain the benefit metric.

12. The method of claim 11, wherein the benefit metric comprises a vector of the input metrics.

13. The method of claim 12, further comprising ranking the buildings according to a size of the vector of the input metrics.

14. The method of claim 11, wherein the input metrics comprise one or more of building surface area, building-cell distance, traffic volume, accessibility KPIs, resource utilization, energy use and consumption, and path loss.

15. The method of claim 1, wherein the topological characteristic of the building comprises a surface area of the building, a distance of the building from a cell of the wireless communication network, and/or a height of the building.

16. The method of claim 1, wherein the network configuration and network performance data are obtained from the wireless communication network operator.

17-21. (canceled)

22. An upgrade recommendation system for a wireless communication network, comprising:
a memory comprising instruction data representing a set of instructions; and
a processor configured to communicate with the memory and to execute the set of instructions, wherein the set of instructions, when executed by the processor, cause the processor to:
obtain network configuration and network performance data for the wireless communication network;
obtain urban infrastructure data for a geographic area of interest;
extract a plurality of building topologies of buildings in the geographic area of interest from the urban infrastructure data;
associate respective ones of the building topologies with one or more cells of the wireless communication network;
assess performance of the wireless communication network at the plurality of buildings based on the network configuration and performance data; and
for each of the buildings, generate a benefit metric indicative of a potential benefit associated with upgrading and/or deploying wireless network equipment based on the assessed performance of the wireless communication network at the building and a topological characteristic of the building obtained from the plurality of building topologies.

23-24. (canceled)

25. A computer program comprising instructions which, when executed on at least one processor, cause the at least one processor to carry out a method according to claim 1.

26-27. (canceled)
